(19) United States
(12) Patent Application Publication
(10) Pub. No.: US 2013/0215224 A1
(43) Pub. Date: Aug. 22, 2013

(54) IMAGE PROCESSING APPARATUS AND METHOD FOR CONTROLLING THE SAME

(71) Applicant: CANON KABUSHIKI KAISHA, (US)

(72) Inventor: Shigeki Mochizuki, Kawasaki-shi (JP)

(73) Assignee: CANON KABUSHIKI KAISHA, Tokyo (JP)

(21) Appl. No.: 13/760,157

(22) Filed: Feb. 6, 2013

(30) Foreign Application Priority Data
Feb. 16, 2012 (JP) 2012-031812

(51) Int. Cl. H04N 13/00

(52) U.S. Cl. CPC H04N 13/0048
USPC 348/43

(57) ABSTRACT

An image processing apparatus which encodes multi-viewpoint moving image data in accordance with a predetermined encoding method, generates converted moving image data each picture of which is a combined image of a right eye image and a left eye image in the multi-viewpoint moving image data, in each of which the number of horizontal pixels is reduced, generates an encoding parameter for encoding the converted moving image data by using the encoding parameter used to encode the multi-viewpoint moving image data, and encodes, in response to the instruction, the converted moving image data, in accordance with the generated encoding parameter, in accordance with an encoding method different from the predetermined encoding method.

### BACKGROUND OF THE INVENTION

1. Field of the Invention

The present invention relates to an image processing apparatus, and particularly to an image processing apparatus provided with an image data encoding function.

2. Description of the Related Art

Conventionally, an apparatus is known which photographs a three-dimensional (multi-viewpoint) image including a left eye image and a right eye image, and records the images in a recording medium. The MPEG4 AVC method is conventionally known as a method of encoding moving image data. In addition, in order to encode multi-viewpoint image data, MPEG4 MVC is proposed which is an extended standard of MPEG4 AVC. The method proposed in MPEG4 MVC uses a prediction encoding method of motion compensation and parallax compensation, and encodes each of the left eye image and the right eye image (for instance, refer to Japanese Patent Application Laid-Open No. 2011-087195).

On the other hand, such a configuration is also considered as to decrease the number of pixels in a horizontal instruction of each of the left eye image and the right eye image to a half, generate two-dimensional image data of a side-by-side method of converting the left eye image and the right eye image to one picture by arranging those images side by side, encode the two-dimensional image data by a motion compensation prediction encoding method, and record the encoded data. As an encoding method at this time, MPEG4 AVC can be used.

In the side-by-side method, the number of pixels in the horizontal instruction of each of the left eye image and the right eye image is reduced into a half. Accordingly, the number of pixels in each of the left eye image and the right eye image is increased at the time of reproduction by interpolation or the like, and the image data is restored. Because of this, an image quality of a restored image deteriorates.

In contrast to this, when multi-viewpoint image data is encoded in accordance with MPEG4 MVC, there is no need to reduce the number of pixels in the left eye image and the right eye image. Because of this, from a viewpoint of an image quality, it is preferable to use a multi-viewpoint image encoding method which encodes each of the left eye image and the right eye image.

However, in an apparatus which cannot decode moving image data encoded by MPEG4 MVC, moving image data encoded by the multi-viewpoint image encoding method cannot be decoded. Therefore, only a two-dimensional image of any one of the left eye image or the right eye image can be decoded.

Then, it is desirable to be capable of simply converting moving image data encoded by the multi-viewpoint image encoding method into a moving image of the side-by-side method, and encoding the moving image.

### SUMMARY OF THE INVENTION

It is a scope of the invention to solve such a problem and enable moving image data encoded by a multi-viewpoint image encoding method to be converted into the side-by-side image efficiently at high speed and then encoded.

In order to achieve the above described object of the present invention, according to the invention, an image processing apparatus having an encoding unit which generates an encoding parameter for encoding multi-viewpoint moving image data and encodes the multi-viewpoint moving image data by using the encoding parameter in accordance with a predetermined encoding method, an image processing unit which processes the moving image data, and an instruction unit which receives an instruction, is arranged such that the image processing unit reduces the number of horizontal pixels in each of a right eye image and a left eye image in the multi-viewpoint moving image data, and generates converted moving image data each picture of which is a combined image of the left eye image and the right eye image, each subjected to reducing the number of pixels, the encoding unit generates an encoding parameter for encoding the converted moving image data by using the encoding parameter used for encoding the multi-viewpoint moving image data, a control unit controls the image processing unit and the generation of an encoding parameter of the converted moving image data in response to the instruction received by the instruction receiving unit to encode the converted moving image data which is generated by the image processing unit, by using the generated encoding parameter in accordance with an encoding method different from the predetermined encoding method.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing apparatus according to a first embodiment of the present invention.

FIG. 2 is a schematic view illustrating an encoding method of multi-viewpoint moving image data.

FIG. 3 is a view illustrating a relationship between a multi-viewpoint image and a side-by-side image according to an exemplary embodiment of the present invention.

FIG. 4 is a view illustrating a macro block division type concerning moving image encoding.

FIG. 5 is a view illustrating a flow chart of encoding processing according to the first embodiment of the present invention.

FIG. 6 is a view illustrating a flow chart of conversion processing according to the first embodiment of the present invention.

FIG. 7 is a conceptual view of conversion processing of a macro block division type according to an exemplary embodiment of the present invention.

FIGS. 8A and 8B are conceptual views of the conversion processing of the macro block division type according to an exemplary embodiment of the present invention.

FIG. 9 is a conceptual view of the conversion processing of the macro block division type according to an exemplary embodiment of the present invention.

FIG. 10 is a conceptual view of the conversion processing of the macro block division type according to an exemplary embodiment of the present invention.

FIG. 11 is a conceptual view of conversion processing of a motion vector according to an exemplary embodiment of the present invention.

FIG. 12 is a conceptual view of conversion processing of a parallax vector according to an exemplary embodiment of the present invention.

FIG. 13 is a block diagram illustrating an image processing apparatus according to a second embodiment of the present invention.

### DESCRIPTION OF THE EMBODIMENTS

Exemplary embodiments of the present invention will now be described in detail in accordance with the accompanying drawings.

### First Embodiment

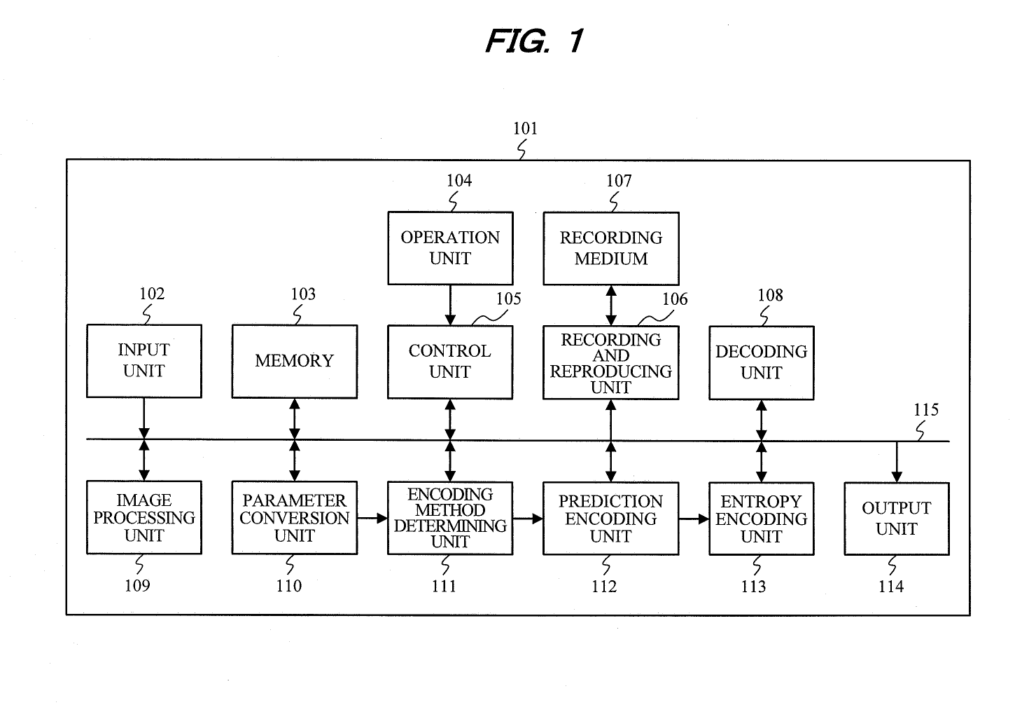

FIG. 1 is a block diagram illustrating a configuration of an image processing apparatus according to a first embodiment of the present invention. An image processing apparatus 101 of FIG. 1 has a configuration which encodes multi-viewpoint moving image data including right eye moving image data and left eye moving image data in accordance with a multi-viewpoint image encoding method such as MPEG4 MVC, and records the encoded data. In addition, the image processing apparatus 101 has also a configuration which reproduces and decodes the encoded multi-viewpoint moving image data, converts the decoded multi-viewpoint moving image data into a side-by-side image, and then encodes the converted image in accordance with MPEG4 AVC.

An input unit 102 inputs the multi-viewpoint moving image data therethrough which includes the right eye moving image data and the left eye moving image data, and stores the input data in a memory 103 through a bus 101. The input unit 102 can input multi-viewpoint moving image data therethrough which is photographed by a video camera, for instance. The memory 103 stores the input moving image data and various information therein. An operation unit 104 has a power source switch, a switch for inputting a user instruction such as start and stop of recording, a reproduction switch, a switch for instructing conversion processing which will be described later, and the like. A control unit 105 has a CPU (microcomputer), a memory and the like, and controls the operation of the image processing apparatus 101 in response to the instruction from the operation unit 104, in accordance with software stored in the memory. A recording and reproducing unit 106 records the encoded multi-viewpoint moving image data in a recording medium 107, and reproduces the encoded multi-viewpoint moving image data from the recording medium 107. The recording medium 107 is a randomly accessible recording medium such as a memory card, for instance, and can be easily mounted on and ejected from the image processing apparatus 101 by a not-shown mounting and ejecting mechanism. A decoding unit 108 decodes the multi-viewpoint moving image data which is reproduced from the recording medium. An image processing unit 109 converts a reproduced multi-viewpoint image into the side-by-side image, in a conversion mode. A parameter conversion unit 110 generates an encoding parameter to be used for encoding the side-by-side image, by using an encoding parameter which is added to the reproduced multi-viewpoint moving image data, in the conversion mode.

An encoding method determining unit 111 determines a parameter such as a slice type or a macro block division type at the time when the multi-viewpoint moving image data or the side-by-side image is encoded and a prediction encoding mode. A prediction encoding unit 112 generates prediction error data according to the encoding parameter which is determined by the encoding method determining unit 111, and generates data to be obtained by orthogonally transforming the generated prediction error data. An entropy encoding unit 113 performs entropy encoding processing to the data sent from the prediction encoding unit 112. An output unit 114 outputs the encoded multi-viewpoint moving image data, the decoded multi-viewpoint moving image data, the encoded side-by-side image data or the like to an external apparatus.

Firstly, processing to be performed when the multi-viewpoint moving image data is recorded will be described below.

In MPEG4 MVC, an image of each viewpoint is defined as a view component, and a plurality of the view components constitute multi-viewpoint encoded data. The view component needs to definitely include a view component of which single component can be decoded and which is encoded in accordance with the MPEG4 AVC method. This view component is referred to as a base view, and other view component is referred to as a non-base view. The base view does not use a parallax compensation prediction which uses an image of a viewpoint other than that of the base view itself as a reference picture, and can use only an intra-picture prediction or an inter-picture prediction which uses a picture of the viewpoint of the base view itself as the reference picture. The non-base view can use the intra-picture prediction or the inter-picture prediction which uses the picture of the viewpoint of the base view itself as the reference picture, and in addition, can use a parallax compensation prediction which uses a picture of a viewpoint other than that of the base view itself as the reference picture. In the present embodiment, an image for the left eye shall be the base view, and an image for the right eye shall be the non-base view.

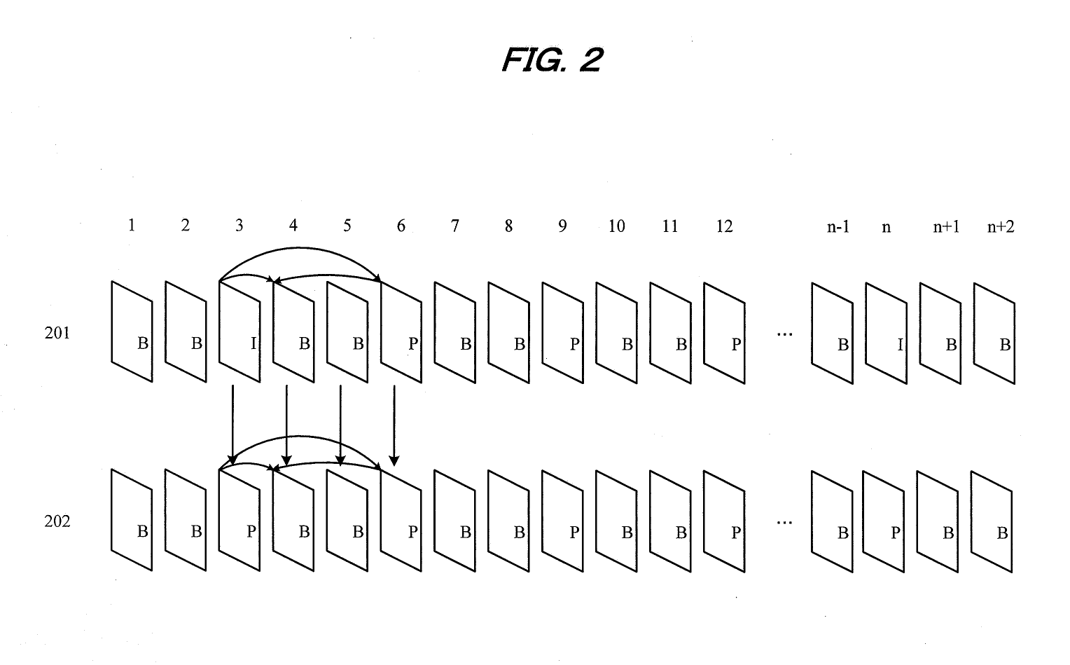

FIG. 2 illustrates a configuration of the multi-viewpoint moving image data. The multi-viewpoint moving image data includes left eye moving image data 201 and right eye moving image data 202. As described above, the left eye moving image data 201 is the base view, and the right eye moving image data 202 is the non-base view. The numbers 1, 2, . . . , and (n+2) described in FIG. 2 represent the order of display of each picture.

I, P and B of FIG. 2 represent an I slice, a P slice and a B slice, respectively. Because the left eye moving image data 201 is the base view, the I slice is encoded by the intra-picture prediction, the P slice is encoded by a forward prediction which uses a forward picture as a reference picture, and the B slice is encoded by a bidirectional prediction which uses forward and backward pictures as a reference picture.

In addition, because the right eye moving image data 202 is the non-base view, the P and B slices can be encoded by using prediction encoding by a parallax prediction which uses the left eye image of the same time as a reference picture, in addition to the forward prediction and the bidirectional prediction, respectively.

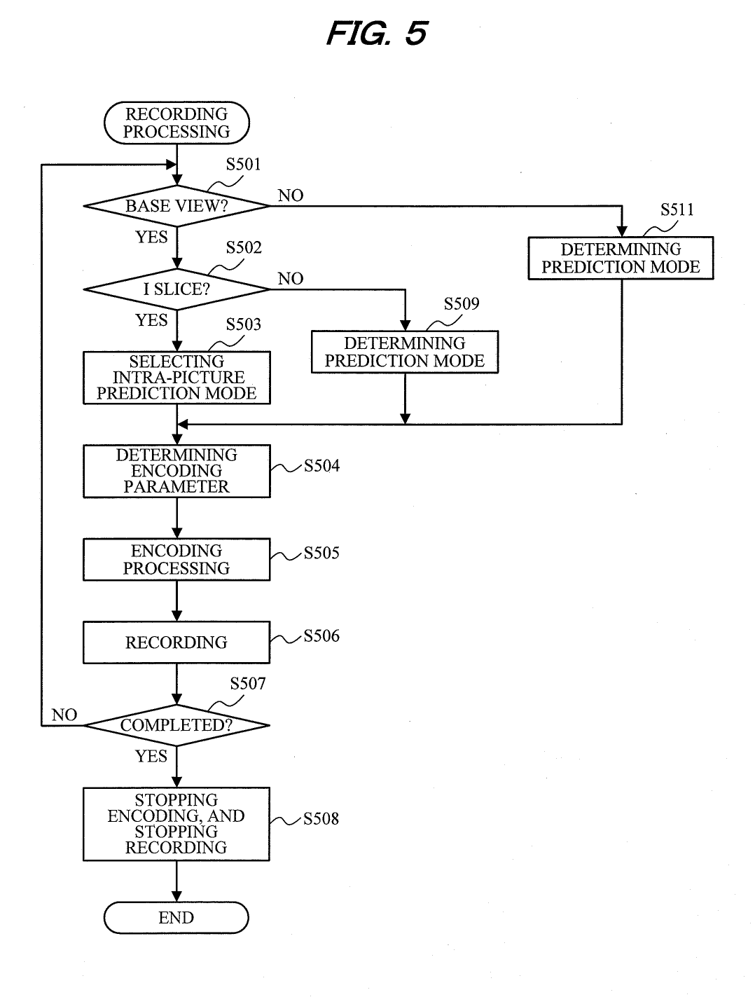

Next, encoding processing by the image processing apparatus 101 will be described below with the use of a flow chart of recording processing illustrated in FIG. 5. The processing illustrated in FIG. 5 is performed by the control unit 105 which controls each unit.

The processing is started in response to such an instruction from the operation unit 104 as to start recording.

The input unit 102 stores the multi-viewpoint moving image data which is input in order of display illustrated in FIG. 2, in the memory 103. The encoding method determining unit 111 reads out the left eye image and the right eye image in the multi-viewpoint moving image data, which are stored in the memory 103, in order of the encoding processing, respectively. The encoding method determining unit 111 discriminates whether a subject macro block of encoding is moving image data of the base view or not (S501). When the subject macro block of encoding is the base view, the encoding method determining unit 111 discriminates whether the subject macro block of encoding is the I slice or not (S502). When the subject macro block of encoding is the I slice, the encoding method determining unit 111 selects a type having higher encoding efficiency from the macro block division types of the intra-picture prediction (S503). On the other hand, when the subject macro block of encoding is not the I slice, the encoding method determining unit 111 appropriately reads out data of the reference picture which is locally decoded, from the memory 103, and performs a simple intra-picture prediction, and an inter-picture prediction processing including the motion compensation prediction or the parallax compensation prediction, to the read out data. Thereby, an evaluation value showing the encoding efficiency is calculated for each macro block. Then, the encoding method determining unit 111 selects a prediction mode having higher encoding efficiency from the intra-picture prediction and the inter-picture prediction, on the basis of the calculated evaluation value (S509).

On the other hand, when the subject macro block of encoding is the non-base view in S501, the encoding method determining unit 106 selects a prediction mode having higher encoding efficiency from the intra-picture prediction and the inter-picture prediction (S511).

Next, the encoding method determining unit 111 determines an encoding parameter such as the macro block division type, a motion vector and a parallax vector, on the basis of the prediction mode of the subject macro block of encoding (S504).

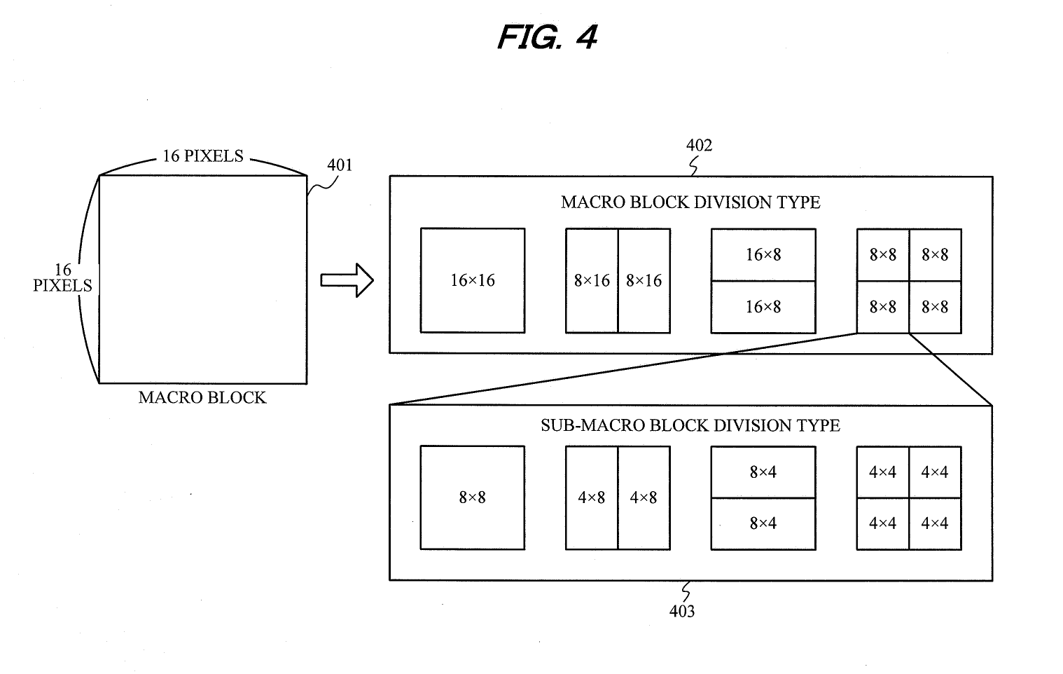

Here, the macro block will be described below with reference to FIG. 4. In MPEG4 MVC and MPEG4 AVC, the encoding processing is performed while using the macro block which includes a predetermined number of pixels, as a unit of encoding. The macro block includes 16 pixels in a horizontal direction and 16 pixels in a vertical direction. In MPEG4 MVC and MPEG4 AVC, a plurality of macro block division types is also prepared. The macro block division type means a division type of smaller blocks into which one macro block is divided.

FIG. 4 is a conceptual view illustrating a division configuration of the macro block. Incidentally, in the figure, the size of the block which illustrates a sub-macro block division type is illustrated so as to be larger than that of the macro block division type, for convenience, in order that the blocks are easily viewed.

MPEG4 MVC is similar to MPEG4 AVC, in regard to the macro block division type which is a unit of the prediction encoding. As is illustrated in FIG. 4, one macro block 401 includes 16 pixels in a horizontal direction and 16 pixels in a vertical instruction. In addition, four types of 16×16 pixels, 8×16 pixels, 16×8 pixels, and 8×8 pixels are defined as the macro block division type 402. When the macro block division type is 8×8 pixels, the unit of 8×8 pixels is referred to as a sub-macro block. Four types of 8×8 pixels, 4×8 pixels, 8×4 pixels, and 4×4 pixels are defined as the sub-macro block division type 403. In each of the macro block division types, an intra-picture prediction mode is set for each divided block, and the motion vector or the parallax vector is calculated for each divided block. In addition, in each of the sub-macro block division types, the intra-picture prediction mode is set for each divided block, and the motion vector or the parallax vector is calculated for each divided block.

From these macro block division types, in the intra-picture prediction, the two macro block division types may be used, which are 16×16 pixels and 8×8 pixels. In addition, two types of 8×8 pixels and 4×4 pixels may be used as the sub-macro block division type. However, as for the sub-macro block division type in one macro block, only one type can be selected. As for the inter-picture prediction including the motion compensation and the parallax compensation, all of the macro block division types can be used, and when the macro block division type of the 8×8 pixels is selected, all of the sub-macro block division types can be used for the sub-macro block.

In this way, the encoding method determining unit 111 selects the macro block division type according to the prediction mode. Then, the encoding method determining unit 111 sends information of the encoding parameter such as the selected macro block division type, the reference picture, the prediction mode and the motion vector, to the prediction encoding unit 112.

The prediction encoding unit 112 encodes the subject macro block of encoding, on the basis of the encoding parameter sent from the encoding method determining unit 111. In other words, when performing the intra-picture prediction, the prediction encoding unit 112 generates prediction error data between the data and the subject macro block of encoding on the same picture, in accordance with the determined prediction mode. In addition, when performing the inter-picture prediction, the prediction encoding unit 112 reads out the data (prediction data) of the reference picture from the memory 103, in accordance with the determined prediction mode, and generates prediction error data (difference) between the subject data of encoding and the reference data. Then, the prediction encoding unit 112 performs orthogonal transform processing on a designated pixel block unit (block unit of 8×8 pixels or 4×4 pixels). The prediction encoding unit 112 quantizes a conversion coefficient which is obtained by the orthogonal transform processing through a quantization step corresponding to the designated quantization parameter, and outputs the quantized data to an entropy encoding unit 113.

The prediction encoding unit 112 also performs inverse quantization processing and inverse orthogonal transform processing with respect to the quantized data, adds the prediction data to the processed data to generate partially decoded data, then stores this partially decoded data in the memory 103. The data which is stored in the memory 103 is used in the subsequent intra-picture prediction processing. Furthermore, the prediction encoding unit 112 performs deblocking filtering processing with respect to the partially decoded data, and then stores the processed data in the memory 103. The data which is stored in the memory 103 after the deblocking filtering processing is used in the subsequent inter-picture prediction processing.

The entropy encoding unit 113 performs entropy encoding processing with respect to the input quantized data, and outputs the processed data to the memory 103 (S505). Here, the entropy encoding processing includes the following two encodings. Specifically, the encodings include context adaptive variable length encoding (Context-based Adaptive Variable Length Coding, which is hereinafter referred to as CAVLC), and context adaptive binary arithmetic encoding (Context-based Adaptive Binary Arithmetic Coding, which is hereinafter referred to as CABAC).

A recording and reproducing unit 106 reads out the encoded multi-viewpoint moving image data from the memory 103, and records the read out data in the recording medium 107. A control unit 105 discriminates whether there is such an instruction from the operation unit 104 as to stop recording or not (S507). When there is not such an instruction as to stop the recording, the recording is continued as it is. In addition, when there is such an instruction as to stop the recording, the control unit 105 instructs each unit to encode the multi-viewpoint moving image data and stop the recording (S508). The recording and reproducing unit 106 stops the recording of the multi-viewpoint moving image data into the recording medium 107, in response to such an instruction as to stop the recording.

Next, reproducing processing of the multi-viewpoint moving image data which is recorded in the above described recording processing will be described below. The control unit 105 instructs each unit to start reproduction, when there is such an instruction from the operation unit 104 as to start the reproduction. The recording and reproducing unit 106 reproduces the encoded multi-viewpoint moving image data from the recording medium 107 in response to such an instruction as to start the reproduction, and sequentially stores the reproduced multi-viewpoint moving image data in the memory 103 through a bus 115. A decoding unit 108 sequentially reads out the multi-viewpoint image encoded data from the memory 103, decodes the read out data, and stores the decoded left eye moving image data and right eye moving image data in the memory 103 once. An output unit 114 reads out the decoded left eye moving image data and right eye moving image data from the memory 103, and outputs the read out data to the outside in order of display.

Next, conversion processing when there is such an instruction from the operation unit 104 as to convert the moving image data into a side-by-side image will be described below. When there is such an instruction from the operation unit 104 as to convert the moving image data into a side-by-side image, in a state in which the multi-viewpoint moving image data is reproduced or in another state, the control unit 105 controls each unit and makes the unit start the conversion processing.

The image processing apparatus 101 performs conversion processing of decoding the reproduced multi-viewpoint moving image data, then converting the decoded multi-viewpoint image into the side-by-side image, and encoding the converted image in accordance with MPEG4 AVC which is a moving image encoding method, in the conversion processing. The image processing apparatus 101 also generates an encoding parameter which is used for encoding the side-by-side image, with the use of the encoding parameter of the reproduced multi-viewpoint moving image data, in the conversion processing.

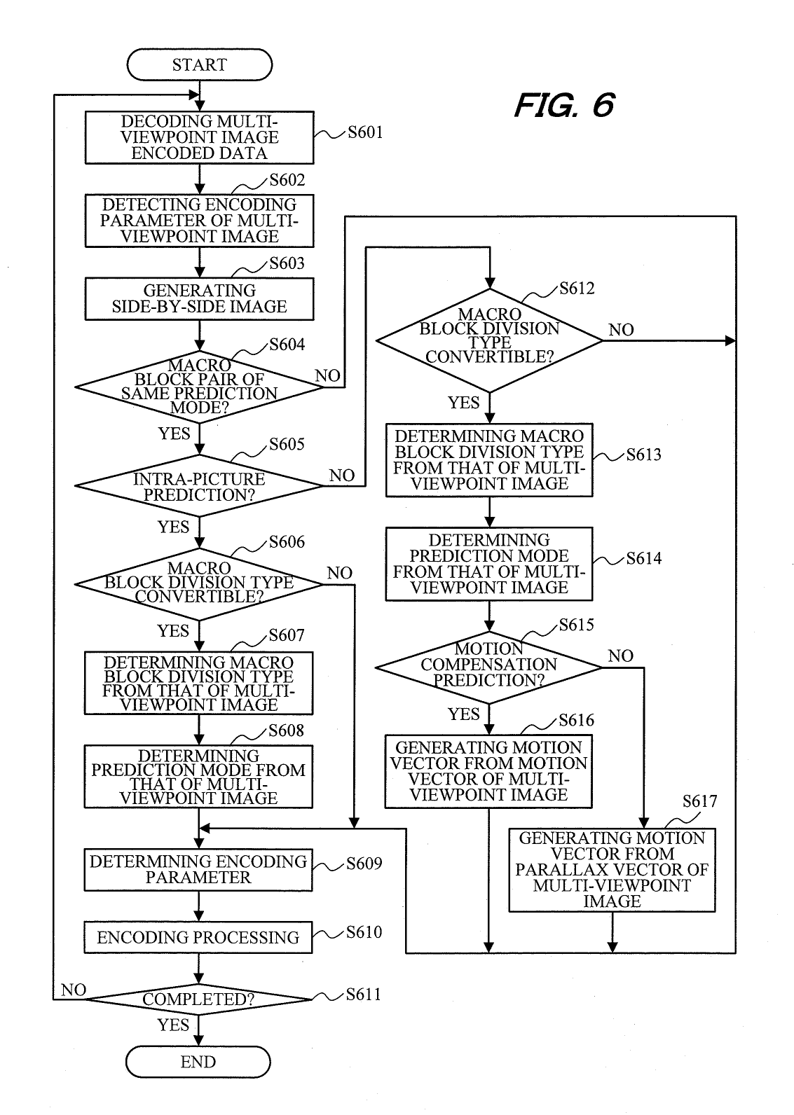

FIG. 6 is a view illustrating a flow chart of conversion processing of the multi-viewpoint moving image data according to the present example. The processing illustrated in FIG. 6 is performed by the control unit 105 which controls each unit.

When the instruction of the conversion processing is input into the control unit 105 from the operation unit 104, the control unit 105 instructs each unit to start the conversion processing. The recording and reproducing unit 106 reproduces the multi-viewpoint moving image data from the recording medium 107, and sequentially stores the reproduced data in the memory 103 through the bus 115. Next, the control unit 105 instructs a decoding unit 108 to start decoding processing. The decoding unit 108 sequentially reads out the multi-viewpoint moving image data from the memory 113, decodes the read out data, and stores the decoded left eye moving image data and right eye moving image data, in the memory 103 once (S601). The decoding unit 108 also stores information of the encoding parameter of each macro block, in the memory 103 (S602).

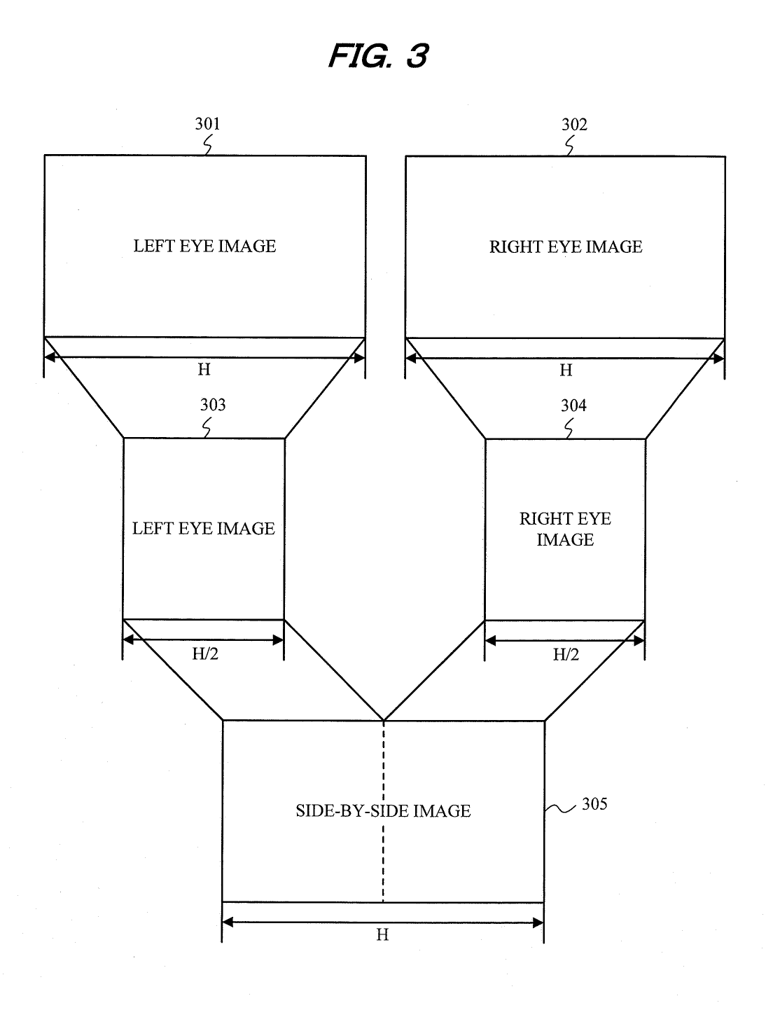

Next, the image processing unit 109 reads out the left eye image and the right eye image of in a same time, from the left eye moving image data and right eye moving image data that are stored in the memory 103. Then, as is illustrated in FIG. 3, the image processing unit reduces the pixels in a horizontal direction of each of the read out left eye image 301 and right eye image 302 to a half, combines the left eye image 303 and the right eye image 304, in each of which the pixel number is each decreased, and generates a side-by-side image 305 (S603). In this way, the image processing unit 109 sequentially generates the side-by-side image (converted moving image data), and stores the generated image in the memory 103.

When the side-by-side image which is stored in the memory 103 is encoded according to MPEG4 AVC, the number of horizontal pixels in each macro block in the left eye image 301 and the right eye image 302 is also decreased to be a half. The two macro blocks which are adjacent in the left eye image 301 and the right eye image 302 forms one macro block in the side-by-side image.

Then, in the present embodiment, the following processing will be performed, in order to determine an encoding mode (encoding parameter) of one macro block in the side-by-side image.

A parameter conversion unit 110 discriminates whether the two macro blocks (referred to as macro block pair), which are adjacent to each other in a horizontal direction in the multi-viewpoint moving image data, are in the same prediction mode or not (S604). In other words, the parameter conversion unit 110 discriminates whether both of the two macro blocks which are adjacent to each other in the same macro block pair are the intra-picture prediction or the inter-picture prediction (motion compensation or parallax compensation).

When the two macro blocks which are adjacent to each other in the macro block pair are in the same prediction mode, the parameter conversion unit 110 discriminates whether this prediction mode is the intra-picture prediction or not (S605). When the prediction mode is the intra-picture prediction, the parameter conversion unit 110 discriminates whether the macro block division type for encoding the side-by-side image can be obtained by converting the number of the horizontal pixels in each macro block division type into a half, or not (S606).

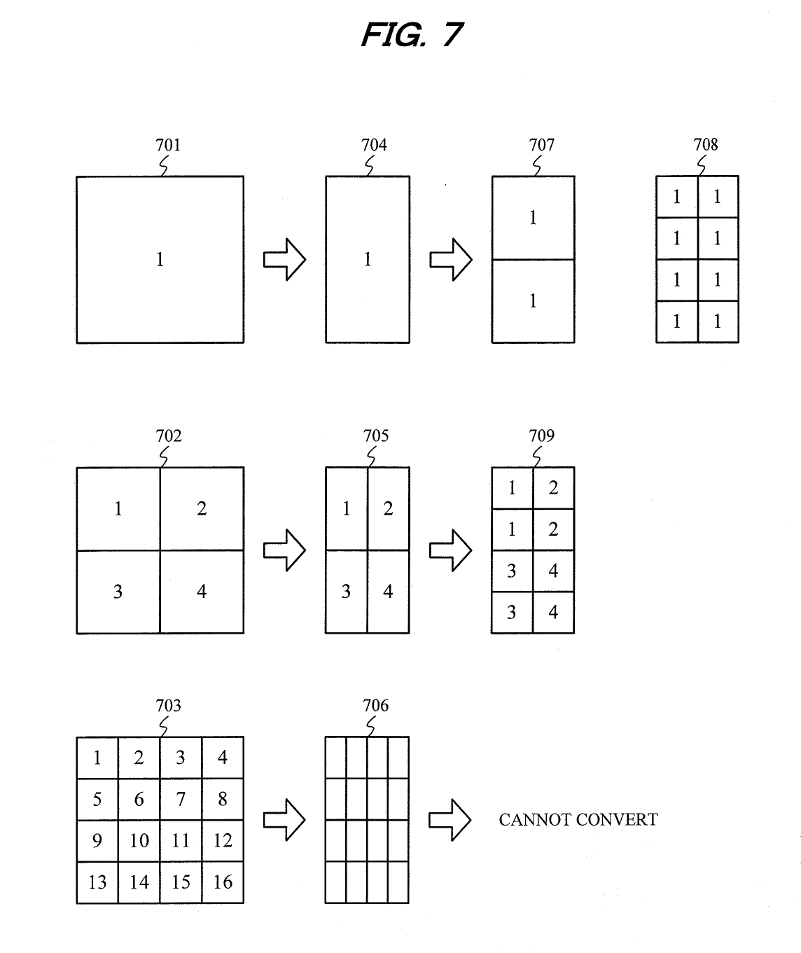

This discrimination will be described below with reference to FIG. 7. As is illustrated in the figure, blocks 704 to 706 are obtained by decreasing the numbers of horizontal pixels of the macro block division type 701 of 16×16 pixels, the macro block division type 702 of 8×8 pixels and the macro block division type 703 of 4×4 pixels, which types are defined, respectively to a half.

The macro block division type 701 of the 16×16 pixels can be converted into a macro block division type 707 of 8×8 pixels, or into a block 708 which is a macro block division type of 8×8 pixels having a sub-macro block division type of 4×4 pixels. The macro block division type 702 of the 8×8 pixels can be converted into a block which is a macro block division type of 8×8 pixels having a sub-macro block division type of 4×4 pixels.

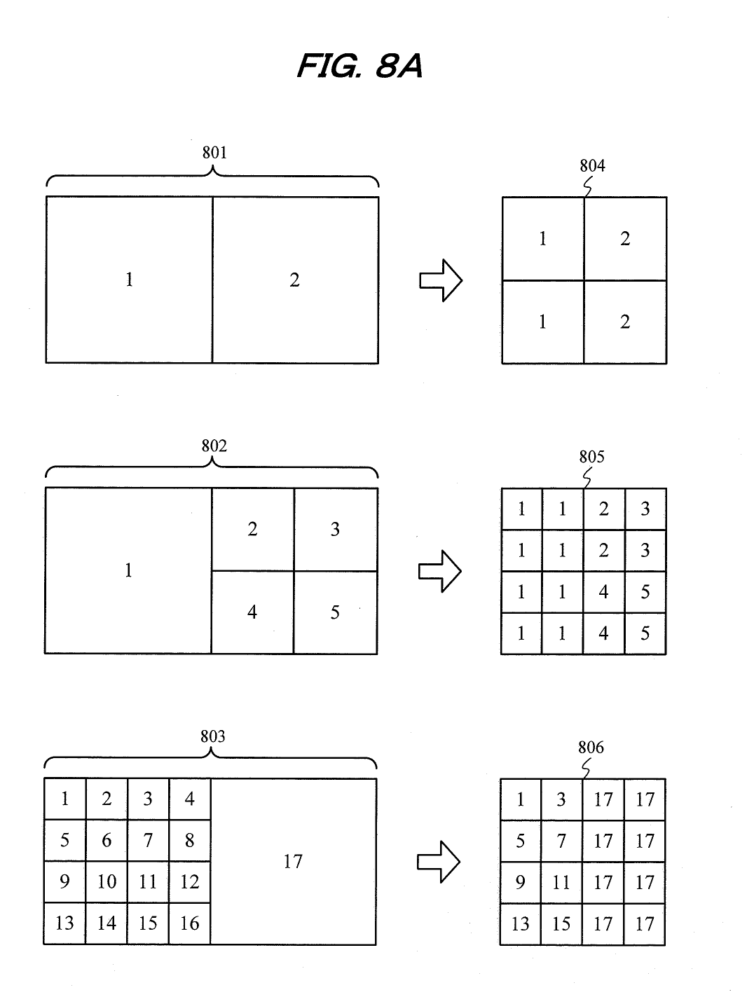

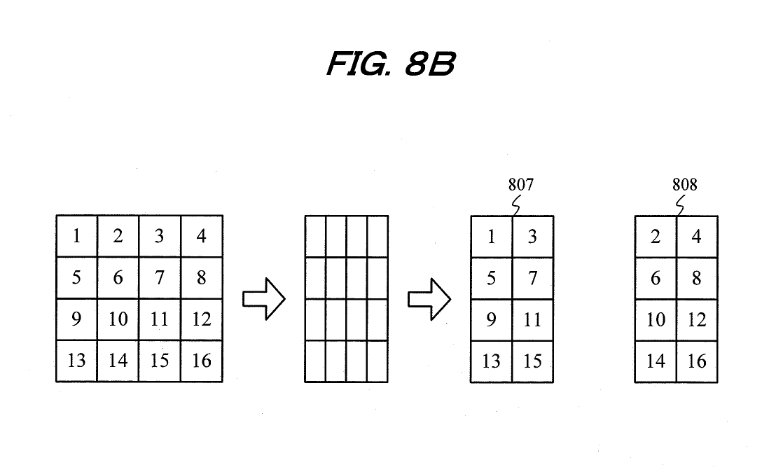

When the size in a horizontal direction of the macro block 703 which is the macro block division type of the 8×8 pixels having the sub-macro block division type of the 4×4 pixels is decreased to a half size, this results in a block in which the number of pixels in horizontal direction is in becoming two as in the block 706. Because of this, the converted block cannot be used as a macro block division type for encoding the side-by-side image. In this case, the parameter conversion unit can determine the conversion of the division type as is illustrated in FIG. 8B which will be described later.

Incidentally, the one macro block of the macro block pair is described in FIG. 7, but it can be considered that the other macro block is also converted into a similar division type through a process of decreasing the size in a horizontal direction to a half size. In other words, any two of blocks 707 to 709 of FIG. 7 become one macro block in the side-by-side image. Then, as is illustrated in FIG. 8A, the two adjacent macro blocks in the original multi-viewpoint image are converted into the one macro block in the side-by-side image.

FIGS. 8A and 8B are views schematically illustrating a determination configuration of a division type, for a macro block in a side-by-side image of the macro block pair. As in the macro block pair 801, when both of the macro block division types of the two macro blocks are 16×16 pixels, the macro block division type 804 in the side-by-side image becomes 8×8 pixels. In addition, when the macro block division types of the two macro blocks are different from each other as in the macro block pair 802 and 803, the macro block division type having a smaller size of the block after having been converted is selected as the macro block division type of the subject macro block of encoding, as in 805 and 806.

In addition, even when the block after conversion becomes a block in which the number of pixels in the unit horizontal direction is two, the block may be converted into a macro block division type 807 or 808 of which the size of the block becomes the minimum, as is illustrated in FIG. 8B.

The parameter conversion unit 110 discriminates whether the block in which the number of the horizontal pixels is decreased to a half can be used as a parameter for encoding the side-by-side image or not, on the basis of each of the macro block division types, as in FIG. 7. When the block can be converted, the parameter conversion unit 110 determines the macro block division type of the subject macro block of encoding, from the macro block division type of the multi-viewpoint image, as is illustrated in FIG. 8A. In addition, when at least one of the macro block pair is the macro block division type which cannot be converted, the parameter conversion unit 110 determines the macro block division type to be encoded regardless of the macro block division type of the multi-viewpoint image, as is illustrated in FIG. 8B (S607).

Next, the parameter conversion unit 110 determines the intra-picture prediction mode of the subject macro block of encoding, from the intra-picture prediction mode of the multi-viewpoint image (S608). The numerals in each block illustrated in FIG. 7 and FIGS. 8A and 8B represent correspondence between the intra-picture prediction modes before and after the conversion. For instance, suppose that portions of the number 1 and the number 2 in the macro block 702 of the multi-viewpoint image illustrated in FIG. 7 are vertical in the intra-picture prediction mode, a portion of the number 3 is DC (average), and a portion of the number 4 is horizontal. In this case, the portions of the number 1 and the number 2 in the subject macro block of encoding shall be vertical in the intra-picture prediction mode, the portion of the number 3 shall be DC (average) therein, and the portion of the number 4 shall be horizontal therein. The encoding parameter for the intra-picture prediction is converted in the above way.

On the other hand, when the prediction mode of the macro block pair is not the intra-picture prediction in S605, the parameter conversion unit discriminates whether the macro block division type for encoding the side-by-side image can be obtained by converting the macro block division type or not (S612).

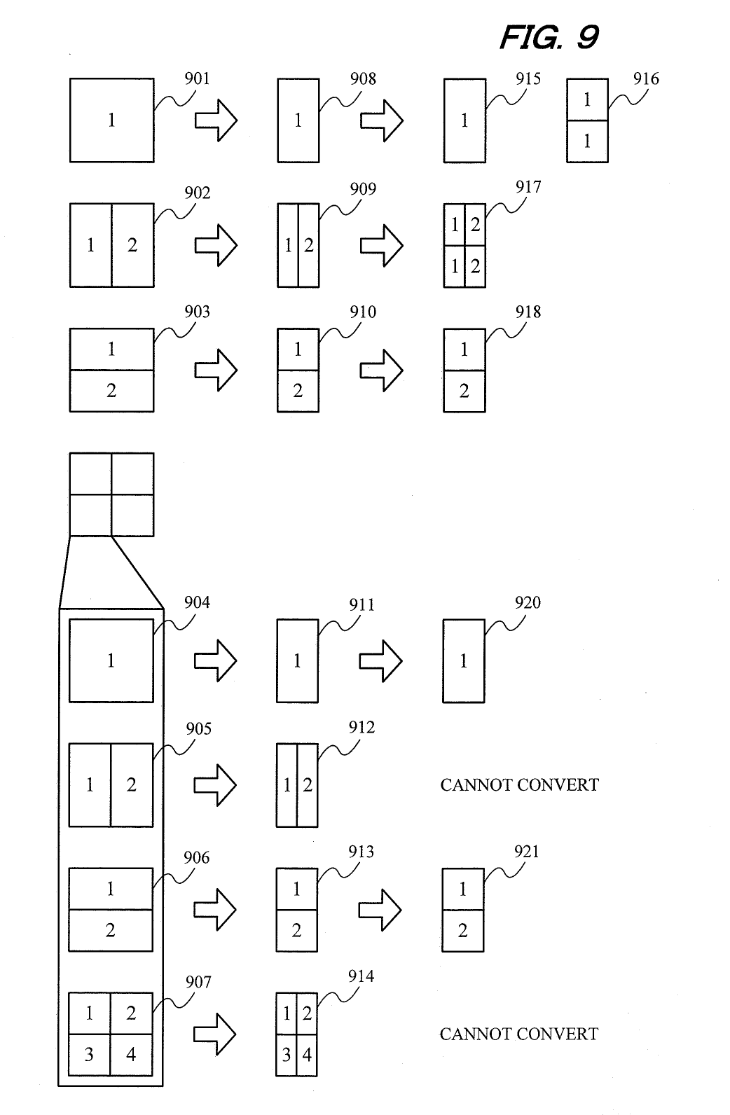

This discrimination will be described below with reference to FIG. 9. Incidentally, in the figure, the size of the block which illustrates a sub-macro block division type is illustrated so as to be larger than that of the macro block division type, for convenience, in order that the blocks are easily viewed.

As is illustrated in FIG. 9, blocks 908 to 910 are obtained by decreasing the number of horizontal pixels of the macro block division type 901 of 16×16 pixels, the macro block division type 902 of 8×16 pixels and the macro block division type 903 of 16×8 pixels, respectively to a half. In addition, blocks 911 to 914 are obtained by decreasing the number of the respective horizontal pixels of the sub-macro block division types 904 to 907 of the macro block division type of 8×8 pixels, to a half. Here, 904 is the sub-macro block division type of 8×8 pixels, 905 is the sub-macro block division type of 4×8 pixels, 906 is the sub-macro block division type of 8×4 pixels, and 907 is the sub-macro block division type of 4×4 pixels.

The macro block division type 901 of 16×16 pixels can be converted into a macro block division type 915 of 8×16 pixels or a macro block division type 916 of 8×8 pixels. The macro block division type 902 of 8×16 pixels can be converted into a block 917 which is a macro block division type of 8×8 pixels having a sub-macro block division type of 4×8 pixels. The macro block division type 903 of 16×8 pixels can be converted into a macro block division type 918 of 8×8 pixels.

The macro block 904 which is a macro block division type of 8×8 pixels having a sub-macro block division type of 8×8 pixels can be converted into a sub-macro block division type 920 of 4×8 pixels. When the size in a horizontal direction of the macro block 905 which is the macro block division type of 8×8 pixels having the sub-macro block division type of 4×8 pixels is decreased to a half size, the number of pixels in the unit results in becoming two as in the block 912. Because of this, the block after conversion cannot be used as a macro block division type for encoding the side-by-side image.

The macro block 906 which is a macro block division type of 8×8 pixels having a sub-macro block division type of 8×4 pixels can be converted into a sub-macro block division type 921 of 4×4 pixels. When the size in a horizontal direction of the macro block 907 which is the macro block division type of 8×8 pixels having the sub-macro block division type of 4×4 pixels is decreased to a half size, the number of pixels in the unit results in becoming two as in the block 914. Because of this, the block after conversion cannot be used as a macro block division type for encoding the side-by-side image.

The parameter conversion unit 110 discriminates whether the block in which the number of the horizontal pixels is decreased to a half can be used as a parameter for encoding the side-by-side image or not, on the basis of each of the macro block division types, as in FIG. 9. When the block can be converted, the parameter conversion unit 110 determines the macro block division type of the subject macro block of encoding, from the macro block division type of the multi-viewpoint image (S613). In addition, when at least one of the macro block pair is the macro block division type which cannot be converted, the parameter conversion unit 110 determines the macro block division type to be encoded, regardless of the macro block division type of the multi-viewpoint image.

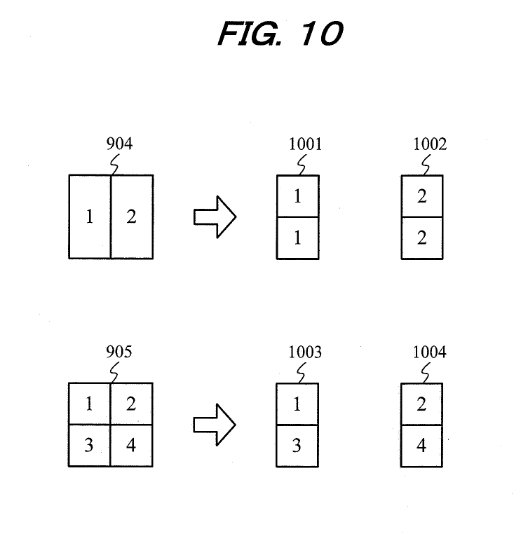

In addition, even when the block after conversion becomes such a block that the number of pixels in the unit is two, as in the sub-macro block division types 905 and 907 of FIG. 9, the block may be converted into macro block division types 1001 to 1004 of which the size of the block becomes the minimum, as is illustrated in FIG. 10.

Next, the parameter conversion unit 110 determines the intra-picture prediction mode of the subject macro block of encoding from the intra-picture prediction mode of the multi-viewpoint image (S614). Next, the parameter conversion unit 110 discriminates whether the prediction mode of the subject macro block of encoding which is determined in S614 is a motion compensation prediction or not (S615). When the subject macro block of encoding is the motion compensation prediction, the parameter conversion unit 110 generates a motion vector of a subject macro block of encoding, by using the motion vector of the macro block of the multi-viewpoint image, which corresponds to the subject macro block of encoding (S616).

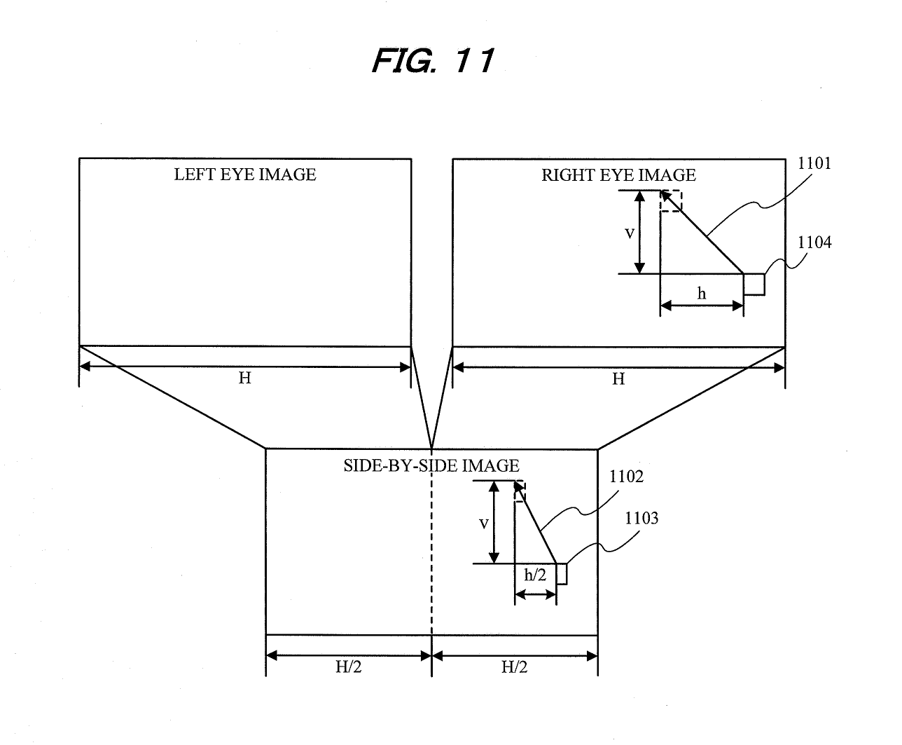

The numerals of each block illustrated in FIG. 9 provide correspondence between subject blocks for which the motion vector block is to be generated before and after the conversion. For instance, the motion vector of the first block in the macro block 917 of the side-by-side image is generated by the conversion of the motion vector of the first block in the macro block 902 of the multi-viewpoint image. The parameter conversion unit 110 generates a motion vector 1102 by decreasing the length in a horizontal direction of a motion vector 1101 of a macro block 1103 of the multi-viewpoint image, which corresponds to a subject macro block 1104 of encoding, to a half, as is illustrated in FIG. 11.

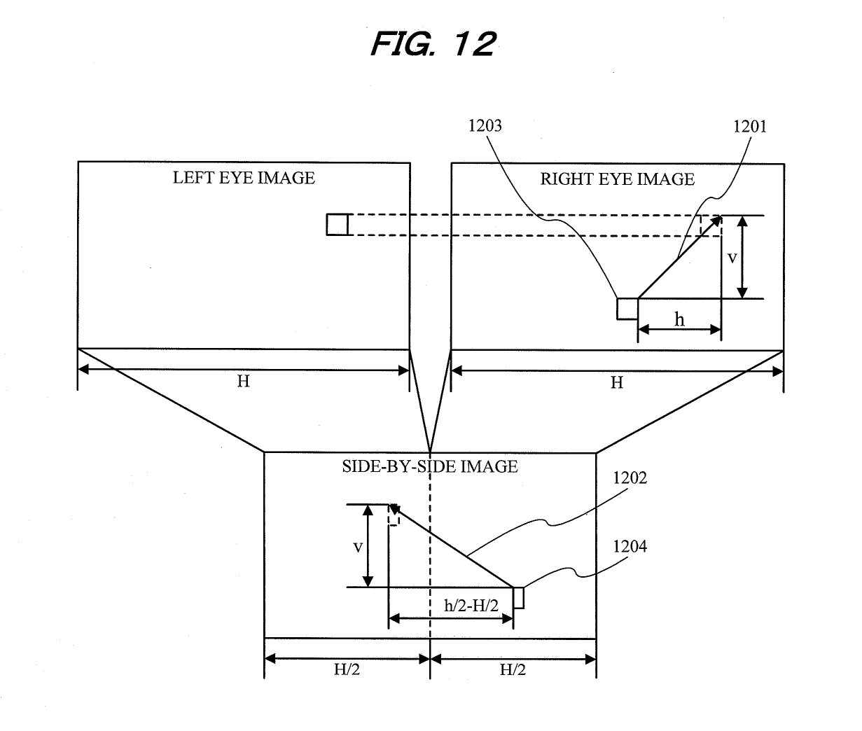

In addition, when the prediction mode of the subject macro block of encoding is not the motion compensation prediction, the subject macro block of encoding is a parallax compensation prediction. The parameter conversion unit 110 generates the motion vector of the subject macro block of encoding, by using the parallax vector of the macro block of the multi-viewpoint image, which corresponds to the subject macro block of encoding (S617). The parameter conversion unit 110 decreases the length in a horizontal direction of a motion vector 1201 of a macro block 1203 of the multi-viewpoint image, which corresponds to a subject macro block 1204 of encoding, to a half, as is illustrated in FIG. 12. Then, an encoding direction determining unit 120 calculates a motion vector 1202 by subtracting an offset value which corresponds to reducing the pixel number in a horizontal direction of one picture in the multi-viewpoint image is decreased to a half, from the length in a horizontal direction of the motion vector.

In addition, when the subject macro block of encoding is the parallax compensation prediction and further is the B slice, the parameter conversion unit 110 sets a picture which is one picture forward of a picture including the subject macro block of encoding, as a reference picture. In addition, when the subject macro block of encoding is the parallax compensation prediction and further is the P slice, the parameter conversion unit 110 sets a picture of the P slice right forward of a picture including the subject macro block of encoding, as a reference picture.

Incidentally, the present embodiment shows the case in which a left eye image is used as a reference picture of a right eye image. However, when the right eye image is used as the reference picture of the left eye image, information of the motion vector is calculated by decreasing a horizontal distance in information of the parallax vector to a half, and adding an offset value of which the number of horizontal pixels of one picture is decreased to a half. Incidentally, when pixel accuracy is decreased to one fourth pixel or less by the conversion of information of the motion vector and the parallax vector, the motion vector and the parallax vector are converted by rounding up the pixel accuracy to one fourth pixel.

In this way, the parameter conversion unit 110 discriminates whether the prediction mode and the macro block division type of the macro block pair in the multi-viewpoint image can be used for encoding the side-by-side image or not. When the prediction mode and the macro block division type can be used, the parameter conversion unit 110 sends the prediction mode and the macro block division type of the subject macro block of encoding or the information of the motion vector, which are generated in the above described way, to an encoding method determining unit 111. In addition, when the prediction mode and the macro block division type cannot be used, the parameter conversion unit 110 sends the information indicating the result to the encoding method determining unit 111. In this way, the parameter conversion unit 110 sends the converted encoding parameter of each subject macro block of encoding or information which indicates that the converted encoding parameter cannot be used, to the encoding method determining unit 111.

When having received the converted encoding parameter, the encoding method determining unit 111 generates each encoding parameter of the macro block division type, the prediction mode, the motion vector and the reference picture of the subject macro block of encoding, on the basis of the encoding parameter (S609). In addition, the parameter conversion unit 110 sets a slice type of a main view (left eye image) in a multi-viewpoint image, which corresponds to the side-by-side image, as a slice type of a picture including the subject macro block of encoding.

On the other hand, when the converted encoding parameter cannot be used, the encoding method determining unit 111 appropriately reads out data of the reference picture from a memory 103, and performs a simple intra-picture prediction and inter-picture prediction processing including the motion compensation prediction. Thereby, the evaluation value showing the encoding efficiency is calculated for each macro block. Then, the encoding method determining unit 111 selects a prediction mode having higher encoding efficiency from the intra-picture prediction and the inter-picture prediction, on the basis of the calculated evaluation value. Then, the encoding method determining unit 111 determines the encoding parameter such as the macro block division type and the motion vector, according to the prediction mode.

The encoding method determining unit 111 outputs the determined encoding parameter as an encoding parameter of the subject macro block of encoding. The control unit 105 instructs the prediction encoding unit 112 to encode the subject macro block of encoding, in accordance with the encoding parameter which is generated by the encoding method determining unit 111. In other words, the control unit 105 achieves the encoding of the side-by-side image by controlling the encoding method determining unit 111, the prediction encoding unit 112 and an entropy encoding unit 113, in a similar way to that for the encoding of the multi-viewpoint moving image data. In this case, a CPU, for instance, of the control unit 105 achieves the encoding processing by loading a control program from a not-shown memory and executing the control program.

The prediction encoding unit 112 encodes the subject macro block of encoding, on the basis of the encoding parameter sent from the encoding method determining unit 111. When performing the intra-picture prediction, the prediction encoding unit 112 generates prediction error data between the data and the subject macro block of encoding on the same picture, in accordance with the determined prediction mode. In addition, when performing the inter-picture prediction, the prediction encoding unit 112 reads out the data (prediction data) of the reference picture from the memory 113, in accordance with the determined prediction mode, and generates prediction error data between the subject data of encoding and the reference data. Then, the prediction encoding unit 112 performs orthogonal transform processing to a designated pixel block unit. The prediction encoding unit 112 quantizes a conversion coefficient which is obtained by the orthogonal transform processing through a quantization step corresponding to the designated quantization parameter, and outputs the quantized data to the entropy encoding unit 113.

The prediction encoding unit 112 also performs inverse quantization processing and inverse orthogonal transform processing with respect to the quantized data, adds the prediction data to the processed data to generate partially decoded data, and then stores this partially decoded data in the memory 103. The data which is stored in the memory 103 is used in the subsequent intra-picture prediction processing. Furthermore, the prediction encoding unit 112 performs deblocking filtering processing with respect to the partially decoded data, and then stores the processed data in the memory 103. The data which is stored in the memory 103 after the deblocking filtering processing is used in the subsequent inter-picture prediction processing.

The entropy encoding unit 113 performs entropy encoding processing by context adaptive variable length encoding (CAVLC) or context adaptive binary arithmetic encoding (CABAC) with respect to the input quantized data, and outputs the processed data to the memory 103 (S610).

The control unit 105 discriminates whether there is such an instruction from the operation unit 104 as to complete conversion processing or not (S611), and when there is such an instruction as to complete the conversion processing, the control unit 105 completes the processing. When there is not such an instruction as to complete the encoding, the process returns to S601, and then processing for the next macro block is continued.

Moving image data which is encoded in this way is stored in the memory 103 once. The output unit 114 outputs the encoded side-by-side image data to an external apparatus.

In this way, in the present exemplary embodiment, the image processing apparatus discriminates whether data obtained by converting the encoding parameter of the multi-viewpoint moving image data can be used when encoding the data in accordance with MPEG4 AVC after having converted the multi-viewpoint moving image data into the data of a side-by-side method, or not. When the converted encoding parameter can be used, the image processing apparatus encodes the side-by-side image by using this converted encoding parameter.

For this reason, the image processing apparatus can convert the moving image data encoded by encoding the multi-viewpoint image into the side-by-side image and encode the image, efficiently at high speed. Thereby, the image processing apparatus can provide the multi-viewpoint moving image data also to an apparatus which cannot decode the multi-viewpoint moving image data which is encoded according to MPEG4 MVC.

In the present exemplary embodiment, the image processing apparatus is configured to record the multi-viewpoint encoded data which is encoded by the image processing apparatus 101, in the recording medium, and convert the multi-viewpoint moving image data which is reproduced from the recording medium, into the side-by-side image. Other image processing apparatus than the above one may be configured to input the encoded multi-viewpoint moving image data thereinto from an external apparatus, decode the input multi-viewpoint moving image data, convert the decoded data into the side-by-side image, and encode the converted side-by-side image.

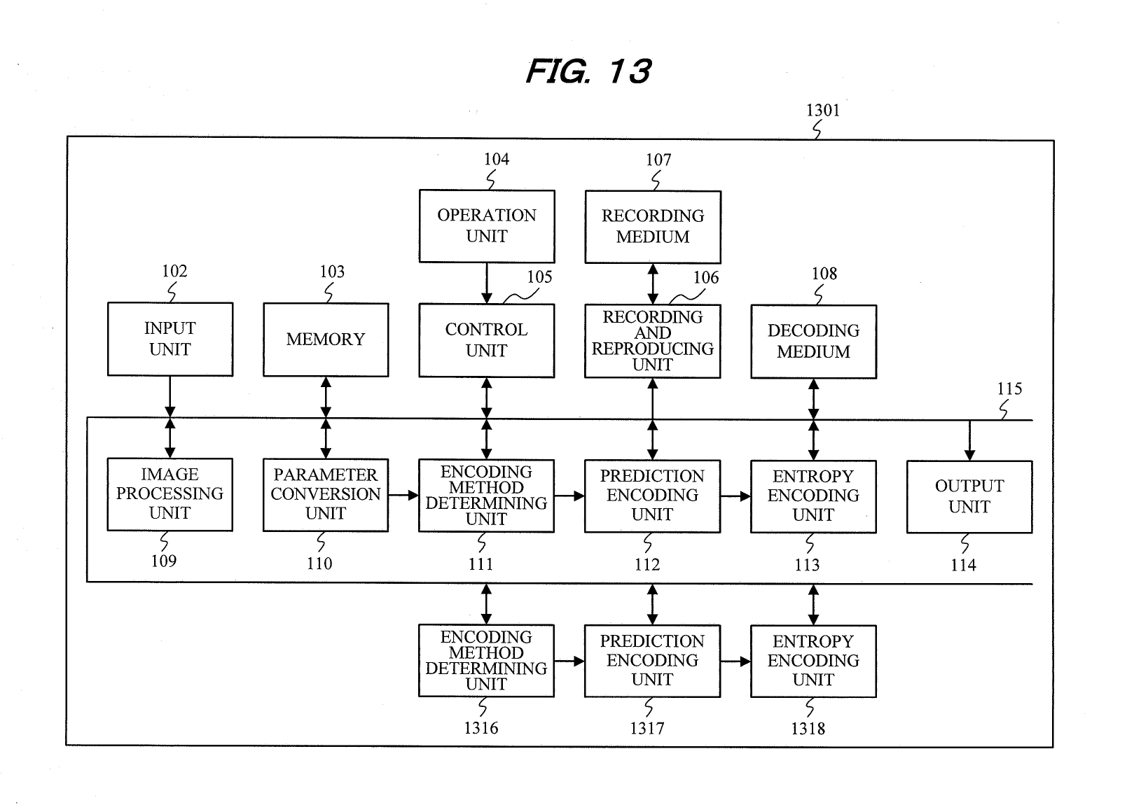

Next, a second embodiment will be described below. FIG. 13 is a block diagram illustrating a configuration of an image processing apparatus 1301 according to a second example. In the image processing apparatus 1301, a configuration similar to that in FIG. 1 is designated by the same number, and the description here will be omitted unless otherwise specifically needed.

The image processing apparatus 1301 of the present example has a configuration in which the image processing apparatus encodes multi-viewpoint moving image data including right eye moving image data and left eye moving image data in accordance with a multi-viewpoint image encoding method such as MPEG4 MVC, in a similar way to that of the image processing apparatus 101 of FIG. 1.

The image processing apparatus 1301 also has a configuration in which the image processing apparatus 1301 converts the input multi-viewpoint moving image data into the side-by-side image, and then encodes the converted image in accordance with MPEG4 MVC, while encoding the input multi-viewpoint moving image data, in parallel.

In FIG. 13, an encoding method determining unit 1316, a prediction encoding unit 1317 and an entropy encoding unit 1318 have similar functions to those of the encoding method determining unit 111, the prediction encoding unit 112 and the entropy encoding unit 113, respectively. In other words, in the first embodiment, the encoding method determining unit 111, the prediction encoding unit 112 and the entropy encoding unit 113 achieves the encoding of the multi-viewpoint moving image data and the encoding of the side-by-side image, under the control of the control unit 105. On the other hand, the present embodiment provides a configuration in which the image processing apparatus has the encoding method determining unit 1316, the prediction encoding unit 1317 and the entropy encoding unit 1318 separately provided therein, so as to clearly show the configuration in which the image processing apparatus performs both encoding processes in parallel. However, it is also possible to attain the configuration in the present embodiment by the configuration of the image processing apparatus of FIG. 1, which depends on the function of the control configuration including a CPU of the control unit 105.

When there is such an instruction as to record the multi-viewpoint moving image data, the image processing apparatus 1301 encodes the multi-viewpoint moving image data with the encoding method determining unit 1316, the prediction encoding unit 1317 and the entropy encoding unit 1318, and records the encoded data in the recording medium 107, in a similar way to that in the first exemplary embodiment. In addition, when there is such an instruction from the operation unit 104 as to perform parallel processing, while the multi-viewpoint moving image data is recorded or while the recording operation is stopped, the image processing apparatus 1301 converts the input multi-viewpoint moving image data into the side-by-side image, and then encodes the converted image, while encoding the multi-viewpoint moving image data, in parallel. When encoding the side-by-side image in accordance with MPEG4 AVC in the parallel processing, the image processing apparatus 1301 generates the encoding parameter of the side-by-side image by converting the encoding parameter generated when the multi-viewpoint moving image data is encoded.

When there is such an instruction from the operation unit 104 as to perform the parallel processing, the control unit 105 instructs each unit to encode the multi-viewpoint moving image data and perform the encoding processing of the side-by-side image. The multi-viewpoint moving image data is encoded by the encoding method determining unit 1316, the prediction encoding unit 1317 and the entropy encoding unit 1318, and the encoded data is recorded in the recording medium 107. In addition, in the present embodiment, the encoding method determining unit 1316 sends information of the encoding parameter which is determined in S504 to the parameter conversion unit 110, in the parallel processing.

In addition, the image processing unit 109 reads out the left eye image and the right eye image which are photographed in the same time period, from the left eye moving image data and right eye moving image data that are stored in the memory 103. The image processing unit 109 decreases the number of pixels in a horizontal instruction of each of the image data to a half, combines the left eye image and the right eye image in each of which the number of the pixels is decreased, and generates the side-by-side image. In addition, as in the above description, the parameter conversion unit 110 discriminates whether a parameter obtained by converting the encoding parameter of the multi-viewpoint moving image data which is sent from the encoding method determining unit 1316 can be used or not, when encoding the data of the side-by-side method, which is converted from the multi-viewpoint moving image data. When the converted encoding parameter can be used, the side-by-side image is encoded by the encoding method determining unit 111, the prediction encoding unit 112 and the entropy encoding unit 113, with the use of this converted encoding parameter. The encoding processing for the side-by-side image is performed in a similar way to that of FIG. 6.

In the parallel processing, the output unit 114 outputs the encoded data of the side-by-side image to an external piece of apparatus.

The image processing apparatus having the above described configuration of the second embodiment can also convert the moving image data which is encoded by encoding the multi-viewpoint image into the side-by-side image and encode the image, efficiently at high speed, in a similar way to that in the first embodiment. Thereby, the image processing apparatus can provide the multi-viewpoint moving image data also to an apparatus which cannot decode multi-viewpoint moving image data which is encoded according to MPEG4 MVC.

Each unit constituting the recording apparatus and each step in the recording method according to the above described embodiments of the present invention can be achieved by the action of a program which is stored in a RAM, a ROM or the like of the computer. The present invention includes also this program, and a storage medium which has the above described program stored therein and can be read by a computer.

In addition, the present invention can provide an exemplary embodiment having a form of a system, an apparatus, a method, a program, a storage medium or the like, for instance. Specifically, the present invention may be applied to a system including a plurality of apparatus, or may be applied to an apparatus including one apparatus.

Incidentally, the present invention also includes the case in which a program (program which corresponds to flow chart illustrated in FIG. 5 and FIG. 6 in exemplary embodiment) of a software which achieves a function of the above described exemplary embodiment is supplied directly or from a remote location to a system or an apparatus. The present invention also includes the case in which the function can be attained by such an action of the computer of the system or the apparatus to read out the above described supplied program code and execute the read out program code.

Accordingly, in order to achieve the functional processing of the present invention by the computer, the above described program code itself which is installed in the computer also achieves the present invention. In other words, the present invention includes also a computer program itself for achieving the function processing of the present invention. In this case, the present invention may be forms of a program which is executed by an object code or an interpreter, script data which is supplied to an operating system, and the like, as long as the forms have a function of the program.

Storage media for supplying the program therethrough include, for instance, a flexible disk, a hard disk, an optical disk and a magnetic optical disk. The storage media further include also an MO, a CD-ROM, a CD-R, a CD-RW, a magnetic tape, a nonvolatile memory card, a ROM and a DVD (DVD-ROM and DVD-R).

As for others, methods for supplying the program include a method of connecting a client computer to a home page of the Internet with the use of the browser of the computer. The program can be supplied by downloading the computer program itself of the present invention or a file which is compressed and includes an automatic installation function to a storage medium such as a hard disk, from the above described homepage.

In addition, the supply can also be achieved by dividing the program code which constitutes the program of the present invention into a plurality of files, and downloading the respective files from different home pages. In other words, the present invention also includes a WWW server which enables a plurality of users to download the program file for achieving the function processing of the present invention through the computer.

In addition, as for another method, the supply can also be achieved by encrypting the program of the present invention, storing the encrypted program in a storage medium such as a CD-ROM, distributing the resultant storage medium to the user, making a user who has cleared a predetermined condition to download key information that decrypts the encryption from a home page through the Internet, and making the user to execute the encrypted program by using the key information and install the program in the computer.

The above described function of the exemplary embodiment is achieved by making the computer execute the read out program. Furthermore, the above described function of the exemplary embodiment can also be achieved by the actual processing of which a part or all are performed by an OS that operates on the computer, on the basis of the instruction of the program.

As for further another method, the above described function of the exemplary embodiment can also be achieved by the actual processing of which a part or all are performed by a CPU or the like provided in a function-expanded board that is inserted into the computer or a function-expanded unit connected to the computer, on the basis of the instruction of the program which is firstly read out from the storage medium and is written in a memory provided in the function-expanded board or the function-expanded unit.

In the above, the present invention is described in detail on the basis of the exemplary embodiments, but the present invention is not limited to these particular exemplary embodiments, and various forms are also included in such a range as not to deviate from the scope of the invention.

While the present invention is described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-031812, filed on Feb. 16, 2012, which is hereby incorporated by reference herein in its entirety.

What is claimed is:

1. An image processing apparatus comprising:
an encoding unit that generates an encoding parameter for encoding multi-viewpoint moving image data including left eye moving image data and right eye moving image data, and encodes the multi-viewpoint moving image data by using the encoding parameter in accordance with a predetermined encoding method;
an image processing unit that reduces the number of horizontal pixels in each of a right eye image and a left eye image in the multi-viewpoint moving image data, and generates converted moving image data each picture of which is a combined image of the left eye image and the right eye image, in each of which the number of pixels is reduced;
a parameter conversion unit that generates an encoding parameter for encoding the converted moving image data by using the encoding parameter used for encoding the multi-viewpoint moving image data by the encoding unit;
an instruction receiving unit that receives an instruction for generating the converted moving image data; and
a control unit which controls the image processing unit and the parameter conversion unit in response to the instruction received by the instruction receiving unit to encode the converted moving image data which is generated in the image processing unit, by using the encoding parameter which is generated by the parameter conversion unit, in accordance with an encoding method different from the predetermined encoding method.

2. The image processing apparatus according to claim 1, further comprising a decoding unit that decodes the multi-viewpoint moving image data that is encoded by the encoding unit, wherein the control unit controls the image processing unit and the encoding unit to generate the converted moving image data from the multi-viewpoint moving image data which is decoded by the decoding unit, and encode the converted moving image data.

3. The image processing apparatus according to claim 2, wherein the multi-viewpoint moving image data which is encoded by the encoding unit includes information of an encoding parameter that is generated for encoding the multi-viewpoint moving image data, and the parameter conversion unit generates an encoding parameter for encoding the converted moving image data by using the information of the encoding parameter concerning the multi-viewpoint moving image data which is decoded in the decoding unit.

4. The image processing apparatus according to claim 1, further comprising: an inputting unit that inputs the multi-viewpoint moving image data; and another encoding unit that encodes the converted moving image data, wherein the control unit controls the image processing unit and the other encoding unit to generate the converted moving image data from the multi-viewpoint moving image data which is input in the inputting unit, and encodes the converted moving image data.

5. The image processing apparatus according to claim 4, wherein the control unit controls such that encoding of the multi-viewpoint moving image data by the encoding unit and encoding of the converted moving image data by the other encoding unit, in parallel.

6. The image processing apparatus according to claim 1, wherein the parameter conversion unit converts the encoding parameter of the multi-viewpoint moving image data in accordance with the predetermined encoding method and the different encoding method, and thereby generates an encoding parameter to be used for encoding the converted moving image data.

7. The image processing apparatus according to claim 6, wherein the parameter conversion unit discriminates whether the encoding parameter for encoding the converted moving image data can be generated by converting the encoding parameter of the multi-viewpoint moving image data, or not, and in a case where it is discriminated that the encoding parameter for encoding the converted moving image data cannot be generated by converting the encoding parameter of the multi-viewpoint moving image data, the encoding unit generates the encoding parameter for encoding the converted moving image data, without using the encoding parameter of the multi-viewpoint moving image data.

8. The image processing apparatus according to claim 1, wherein the predetermined encoding method and the different encoding method are prediction encoding which encodes difference between subject data of encoding and reference data, and the encoding parameter for encoding the converted moving image data includes a plurality of prediction modes of the prediction encoding.

9. The image processing apparatus according to claim 8, wherein the plurality of the prediction modes includes intra-picture prediction, motion compensation prediction and parallax compensation prediction.

10. The image processing apparatus according to claim 8, wherein the encoding unit performs encoding on the unit basis of a block including the predetermined number of pixels, and the parameter conversion unit uses prediction modes of two blocks adjacent in a horizontal instruction in the multi-viewpoint moving image data as prediction modes of a block in the converted moving image data, in a case where prediction modes of the two blocks are the same.

11. The image processing apparatus according to claim 1, wherein both the predetermined encoding method and the different encoding method perform encoding on the unit basis of a block including a predetermined number of pixels, and can use any one type of a plurality of block division types each of which includes the predetermined number of the pixels, and the parameter conversion unit determines a block division type of a block in the converted moving image data on the basis of a block division type of a block in the multi-viewpoint moving image data.

12. The image processing apparatus according to claim 10, wherein the parameter conversion unit decides a block division type of the block in the converted moving image data, on the basis of a block division type of a block in the multi-viewpoint moving image data, in a case where the data in which the number of pixels in a horizontal instruction of the block in the multi-viewpoint moving image data is decreased can be used as the block division type of the block in the converted moving image data.

13. A method for controlling an image processing apparatus that includes a memory which stores multi-viewpoint moving image data including left eye moving image data and right eye moving image data therein, an encoding unit that generates an encoding parameter for encoding the multi-viewpoint moving image data that is stored in the memory, and encodes the multi-viewpoint moving image data by using the encoding parameter in accordance with a predetermined encoding method, an image processing unit that processes the moving image data, and an instruction receiving unit that receives an instruction, comprising:
an image processing step of, by the image processing unit, reducing the number of horizontal pixels in each of a right eye image and a left eye image in the multi-viewpoint moving image data that are stored in the memory, and generating converted moving image data each picture of which is a combined image of the left eye image and the right eye image, in each of which the number of pixels is reduced;
a parameter conversion step of generating, by a parameter conversion unit, an encoding parameter for encoding the converted moving image data by using the encoding parameter used for encoding the multi-viewpoint moving image data that is stored in the memory, by the encoding unit;
an instruction receiving step of receiving an instruction for generating the converted moving image data by the instruction receiving unit; and
a control step of controlling the image processing step and the parameter conversion step in response to the instruction received in the instruction receiving step, to encode the converted moving image data that is generated in the image processing step, by using the encoding parameter that is generated in the parameter conversion step, in accordance with an encoding method different from the predetermined encoding method.

14. A non-transitory computer-readable storage medium storing program code for causing a computer to control an image processing apparatus that includes a memory which stores multi-viewpoint moving image data including left eye moving image data and right eye moving image data, an encoding unit that generates an encoding parameter for encoding the multi-viewpoint moving image data that is stored in the memory, and encodes the multi-viewpoint moving image data by using the encoding parameter in accordance with a predetermined encoding method, an image processing unit that processes the moving image data, and an instruction receiving unit that receives an instruction, comprising:
a first program code means for, by the image processing unit, reducing the number of horizontal pixels in each of a right eye image and a left eye image in the multi-viewpoint moving image data which is stored in the memory, and generating converted moving image data each picture of which is a combined image of the left eye image and the right eye image, in each of which the number of pixels is reduced;
a second program code means for generating, by a parameter conversion unit, an encoding parameter for encoding the converted moving image data by using the encoding parameter used for encoding the multi-viewpoint moving image data that is stored in the memory, by the encoding unit;
a third program code means for receiving an instruction for generating the converted moving image data, by the instruction receiving unit; and
a fourth program code means for controlling the image processing unit and a parameter conversion unit in response to the instruction received by the instruction receiving unit to encode the converted moving image data that is generated by the image processing unit, by using the encoding parameter that is generated by the parameter conversion unit, in accordance with an encoding method different from the predetermined encoding method.
